(19) United States
(12) Patent Application Publication
(10) Pub. No.: US 2002/0139656 A1
(43) Pub. Date: Oct. 3, 2002

(54) Solar still

(76) Inventor: Jeffrey Thomas Reid, Earlwood (AU)

Correspondence Address: Richard J. Streit, Ladas & Parry, Suite 1200, 224 South Michigan Avenue, Chicago, IL, 60604, US

(21) Appl. No.: 10/068,128

(22) Filed: Feb. 5, 2002

(30) Foreign Application Priority Data
Feb. 6, 2001 (AU) PR 2893

(51) Int. Cl. B01D 3/42

(52) U.S. Cl. 203/1; 203/2; 203/10; 203/86; 203/87; 203/100; 203/DIG. 1; 202/160; 202/186; 202/234; 202/267.1; 202/206; 159/903; 159/DIG. 28

(57) ABSTRACT

There is disclosed a solar still having a hollow, porous absorber body (8), body positioning means (9) to expose the absorber body to solar radiation, feed means (13) to introduce feed liquid into the absorber body, condenser means (14) composed of non-porous material that is substantially transparent to solar radiation, the condenser (14) substantially enveloping the absorber body (8), flow control means (19) to regulate the rate of flow of feed liquid into the absorber body (8), and harvesting means (23) for the removal of distillate from the condenser means (14).

### TECHNICAL FIELD

This invention relates to stills, that is to say apparatus whereby a feed liquid is heated and vapour arising from the heated feed liquid is condensed into a distillate for recovery as a useful product. More particularly the invention relates to stills wherein solar energy is used to heat the feed liquid.

The invention was devised primarily to treat aqueous solutions, for example waste water, seawater or other contaminated water, for the production of potable water, and is described primarily hereinafter with that application in mind. However it will be appreciated that it is applicable generally to the distillation of solvent from other solutions and the separation of more volatile fractions of mixtures of liquids from a less volatile remainder.

### BACKGROUND ART

It has previously been proposed to use solar energy to heat water for domestic or other use. This is often done by simple, passive solar energy conversion apparatus wherein feed water circulates through an extended, at least partly hollow, absorber body, for example a thermally conductive, tortuous tube in close contact with a substantially planar thermally conductive substrate, exposed to the sun. The absorber body is customarily black in colour to enhance its absorbency of solar radiation. Generally that surface of the absorber body that is not exposed to the sun is covered with thermal insulation. Frequently the absorber body is enclosed in a casing with a transparent wall, through which solar radiation impinges on the absorber body, and which reduces energy loss to the atmosphere. Such passive apparatus is simple, inexpensive to make and run, and quite effective for the production of hot water, at least in hot and sunny locations.

It is also well known to use more technically sophisticated, active solar energy conversion apparatus to produce steam for power generation and the like. Such prior known active apparatus has comprised a parabolic trough reflector, means to mount and continuously redirect the reflector so that it tracks the sun, that is to say so that its parabolic axis remains directed towards the sun as it moves across the sky, and a relatively small diameter absorber tube axially coincident with the focal line of the parabola through which feed water is caused to flow for conversion into pressurised steam.

### SUMMARY OF THE INVENTION

An objective of thc invention is to provide a solar still that is a modification of prior known solar energy conversion apparatuses rendering them uniquely adapted for use as a still. The invention attains that objective by replacing the conventional absorber body of such an apparatus by an absorber body made of porous material and by substantially enveloping the porous absorber body in a vapour condenser made of material that is substantially transparent to solar radiation.

Therefore, according to a first aspect, the invention consists in a solar still comprising a hollow, porous absorber body, body positioning means to expose the absorber body to solar radiation, feed means to introduce feed liquid into the absorber body, condenser means, of non-porous material that is substantially transparent to solar radiation, substantially enveloping the absorber body, flow control means to regulate the rate of flow of feed liquid into the absorber body, and harvesting means for the removal of distillate from the condenser means.

Passive stills according to the first aspect of the invention are analogous to passive solar energy conversion apparatuses. Active stills according to the first aspect of the invention are analogous to active solar energy converting apparatuses, in that they further comprise reflecting means to concentrate solar energy on the absorber body and tracking means that, in use, cause the reflecting means to move so as to track the sun.

In preferred stills according to the first aspect of the invention, irrespective of whether they are active or passive, the absorber body comprises at least one rigid, porous tube of darkly coloured, preferably black, sintered ceramic material, for example un-glazed, pigmented porcelain or earthenware, and the condenser means comprises at least one non-porous tube through which the at least one porous tube extends without making contact therewith. Neither tube is necessarily circular in cross-section. The feed means deliver feed liquid into an open end of the porous tube. The other end of the porous tube is closed.

For preference, in passive stills according to the first aspect of the invention, the absorber body comprises a plurality of porous elements, for example tubes that are closed at one end. In these instances the condenser means may comprise a single envelope for all of the porous elements. However, for preference, the condenser means in these instances comprises a like plurality of non-porous elements, for example tubes, respectively associated with the porous elements with each non-porous element substantially enveloping its associated porous element.

For preference, ill both passive and active stills according to the first aspect of the invention, the flow control means comprise an electrically operated valve, controlled by an electronic control unit responsive to signals from a thermometric element immersed in, or otherwise in thermally conducting relationship with, the liquid within the absorber body. The flow control means operate to achieve an operating temperature within the absorber body as close as possible to, but no more than, 100° C. during daylight hours. For preference the control unit also receives signals from an ambient light photo-detector and, depending on the control unit's programming, closes the valve during the night for shut-down, and/or opens the valve for a predetermined nightly period to flush the porous material and outer surface of the absorber body with expendable feed liquid.

In active embodiments of the invention the reflecting means preferably comprise a parabolic trough reflector and tracking means therefore. In these instances the electronic control unit may also receive inputs from further, directional, photodetectors moving as one with the reflector to enable the control unit to control motors included in the tracking means to effect independently controlled rotation of the reflector about vertical and horizontal axes, so as to cause the reflector to track the sun when the still is active. Such tracking arrangements are well known per se in relation to active solar energy conversion apparatus and need no detailed description herein. It should be mentioned however that for preference, rotation of the reflector about the horizontal axis is independent of the absorber body and the condenser means, whereas that body and those means rotate as one with the reflector about the vertical axis.

According to a second aspect of the invention it consists in a method of distilling a feed liquid to produce a desired distillate comprising the steps of maintaining a flow of feed liquid into a porous, hollow absorber body, exposing the absorber body to solar radiation, and condensing resultant vapour arising from the absorber body.

### BRIEF DESCRIPTION OF THE DRAWINGS

By way of example, two embodiments of the invention are described in more detail hereinafter with reference to the accompanying drawings

FIG. 1 is a plan view of a passive solar still according to the invention, with a part intermediate its ends removed to reduce the width of the figure.

FIG. 2 is an end elevation of the still of FIG. 1.

FIG. 3 is a front elevation of an active solar still according to the invention.

FIG. 4 is an end elevation of the still of FIG. 3.

FIG. 5 is a plan view of the still of FIG. 3.

FIG. 6 is a detail sectional view of a left end portion of the still as seen in FIG. 3, taken on line 6-6 of FIG. 4, drawn to a larger scale.

FIG. 7 is a view similar to FIG. 6 of a right end portion of the still as seen in FIG. 3.

### BEST MODE OF PUTTING THE INVENTION INTO EFFECT

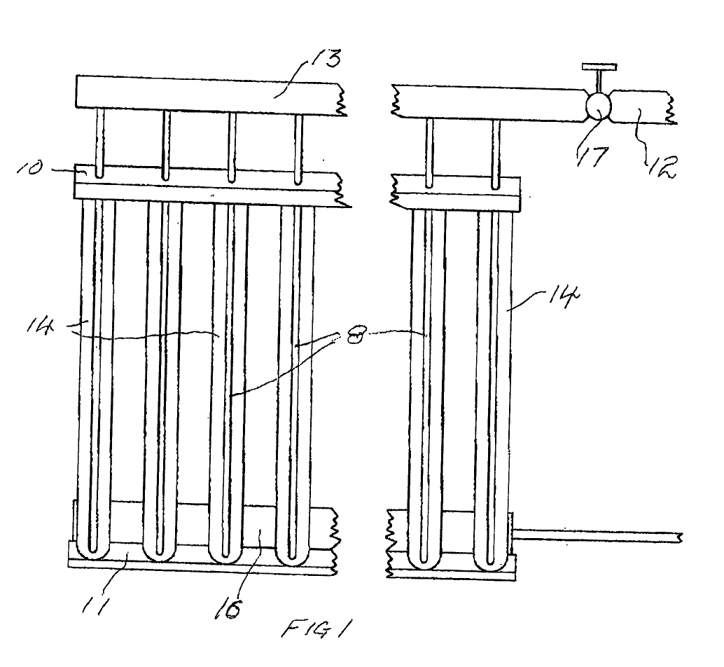

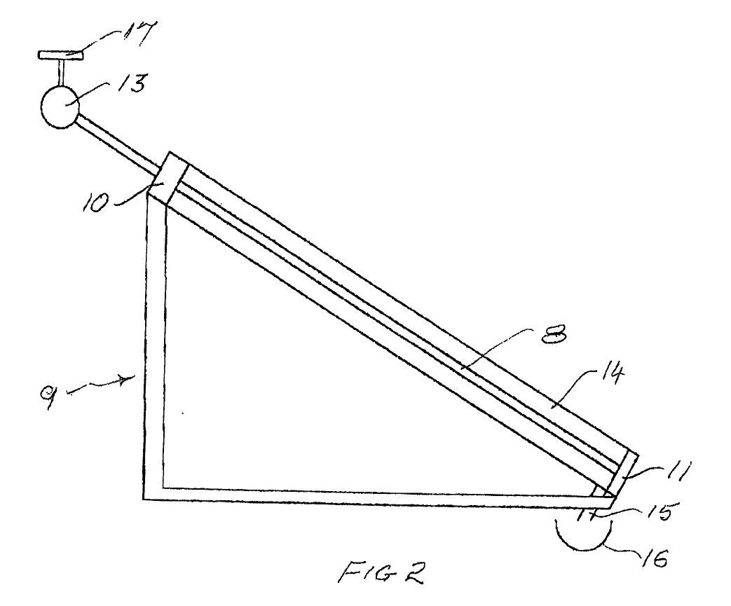

The passive solar still illustrated by FIGS. 1 and 2 includes a hollow absorber body comprising a plurality of body elements, each in the form of a rigid porous tube 8. Each tube 8 is of darkly coloured, preferably black, sintered ceramic material, for example unglazed pigmented porcelain or earthenware.

The tubes 8 are maintained in a substantially planar array, wherein they are parallel and equally spaced apart, by body positioning means in the form of a skeletal frame 9 including transverse members 10 and 11. The frame member 10 is more elevated than the frame member 11, so that the tube array is inclined to the horizontal. As is well known, the angle of inclination may be selected to suit the geographic location of the still to maximise the exposure of the tube array to solar radiation. In each instance the lower ends of the tubes 8 are closed-off to prevent flow of liquid therefrom.

The tubes 8 are maintained full of liquid to be treated when the still is in use by supply means comprising a feed pipe 12 extending from an elevated or pressurised source (not shown) of such liquid, and terminating in a header 13 for the distribution of tile feed liquid into the open ends of each of the tubes 8.

The frame members 10 and 11 also support condenser means in the form of a plurality of tubes 14 of a non-porous material, for example a glass that is: substantially transparent to solar radiation. Preferably the material and wall thickness of the tubes 14 are such that they may withstand heavy hail without breakage. It will be seen that each non-porous tube 14 substantially envelops an associated porous tube 8.

In use, the tubes 8 absorb solar radiation and become hot, as does the liquid within them. It has been found in experiments leading to the present invention that liquid, and possibly some vapour, passes through the porous walls of the porous tubes 8. Liquid emerging at the surface, of the porous tubes 8 is then vaporised. If the flow rate is correctly adjusted, continuous, substantially drip-free vaporisation of the feed liquid may be achieved. The vapour then condenses as distillate on the inner surface of the non-porous tubes 11.

The distillate trickles down to the lower ends of the non-porous tubes 11 and discharges through harvesting means, comprising outlet spouts 15 and a collection gutter 16, for deliver into an appropriate storage vessel.

It will be apparent that a correct flow rate of feed liquid into the porous tubes 8 is critical if maximum throughput and pure distillate is to be obtained at whatever intensity of solar radiation pertains at the time.

It was discovered, in experiments leading to the present invention, that the correct flow rate is proportional to the temperature of the liquid within the tubes 8. Thus flow control means are provided including a control valve 19 in the feed pipe 12 closely upstream of the header 13 In this simple, passive version of the invention the valve 19 may be a manual valve that is set by the operator in the light of past experience. Alternatively, and preferably, the valve 19 is controlled by an electronic control unit in response to signals from a thermometric element immersed in, or otherwise in thermally conducting relationship with, the liquid within the tubes 8. The control unit is preferably programmed to produce an operating temperature close to, but no more than, 100° C.

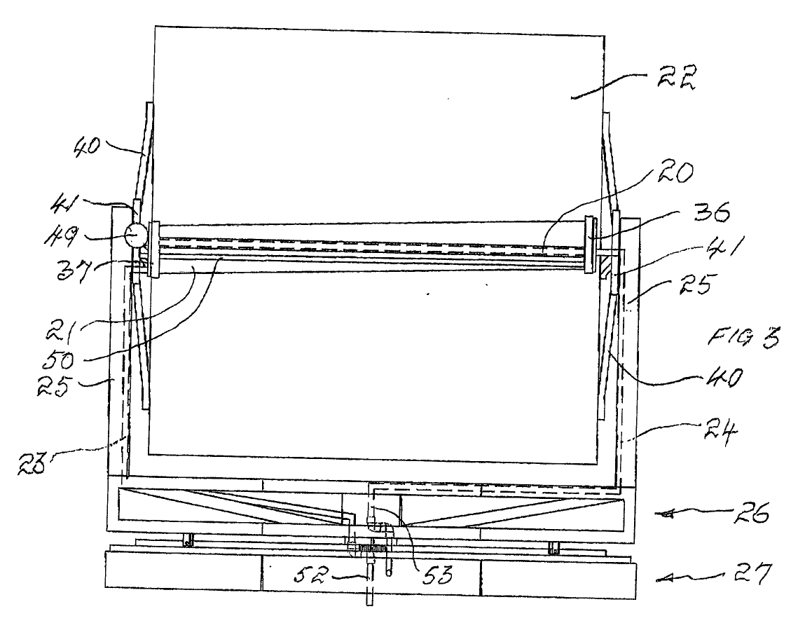

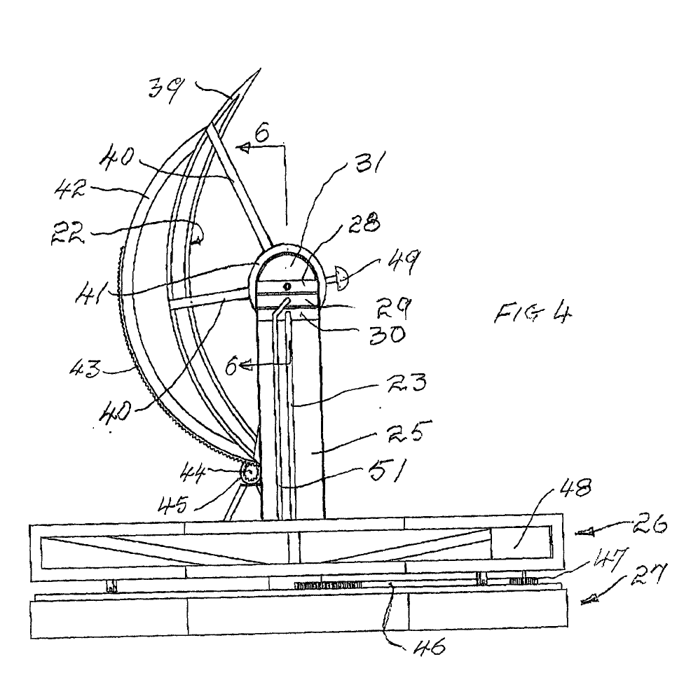

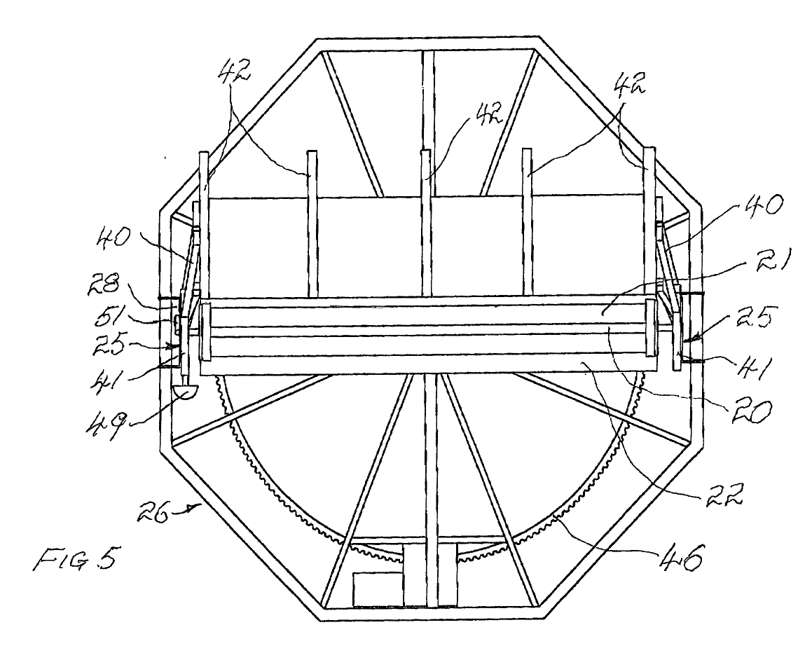

The active embodiment of the invention illustrated by FIGS. 3 to 7 includes an absorber body/condenser combination similar in construction and materials and identical in function to each of the elemental porous tube 8/non-porous tube 14 combinations of the illustrated passive embodiment.

In the present instance however there is only one such combination, namely a porous absorber tube 20 and a non-porous condenser tube 21. Those tubes have the same physical characteristics as the corresponding tubes 8 and 14 respectively of the FIG. 1 embodiment.

The body positioning means of the active still now being described hold thc porous tube 20 so that it extends horizontally and is substantially axially co-incident with the focal line of a parabolic trough reflector 22, being a component of the reflecting means of this active still.

The non-porous condenser tube 21 inclines slightly downwardly so as to discharge distillate through harvesting means comprising a discharge pipe 23 extending to a collector receptacle (not shown).

The porous tube 20 is supplied at one end with feed liquid by feed means comprising a feed pipe 24 extending from an elevated or pressurised source of feed liquid (not shown). The opposite end of the porous tube is closed-off to prevent the egress of feed liquid therefrom.

The flow of feed water into the porous tube 20 is controlled by flow control means including an electrically operated control valve (not shown) that are essentially the same as the flow control means of the above described passive embodiment of the invention.

The porous tube 20 and non-porous tube 21 are supported at each end by body positioning means comprising channel-sectioned pillars 25 extending upwardly from a fabricated turntable 26 mounted for rotation about a vertical central axis upon a stationary fabricated base 27. One pillar 25 carries three support bars 28, 29 and 30 extending from one channel flange of the pillar to its other channel flange across a circular cutout opening 31 in the web of the pillar. The opening 31 is rimmed by a bearing spigot 32. The other pillar 25 has a similar opening 31 that is rimmed by a similar bearing spigot 32 but is spanned by only a single support bar 33.

The ends of the porous tube 20 are supported by cantilever fittings 34 and 35 extending fixedly from the support bars 28 and 33 respectively. Those fittings also fixedly support end-caps 36 and 37 carrying, and liquid-tightly engaging, corresponding ends of the non-porous tube 21.

The cantilever fitting 35 is tubular and liquid-tightly engages one end of the feed pipe 24 for the delivery of feed liquid into the porous tube 20. The cantilever fitting 34 closes the other end of the porous tube 20 and defines a recess 38 adapted to house a thermometric element (not shown) in thermally conductive relationship with feed liquid within he porous tube 20. The recess 38 is open ended to enable a signal transmission cable or capillary tube to extend through the fitting to the thermometric element.

The end-cap 37 is pierced by a tubular connector 38 adapted at one end to engage the discharge pipe 23 and open at its other end to the lowest part of the interior of the null-porous tube 21 for the receipt of distillate therefrom.

As well as the reflector 22 itself, the reflecting means comprise a curved backing frame 39 supporting die parabolic reflecting surface and angularly spaced spokes 40 at each end of the backing frame extending rigidly to two bearing rings 41 encircling the respective spigots 32, whereby the reflector 22 may rotate about its focal line and the coincident axis of the porous tube 20. The backing frame 39 is braced by five part-circular ribs 42 with their centres of curvature coincident with the focal line and the axis of the porous tube 20.

One of the ribs 42, preferably the centre one, bears a vertical, part-circular rack 43 engaged by a pinion 44 on the output shaft of a geared motor 45 carried by the turntable 26, ail of which are components of the tracking means of the embodiment of the invention now being described, for effecting the aforesaid rotation of the reflector 22 about its focal line and the coincident axis of the porous tube 20.

Those tracking means further comprise a horizontal, circular rack 46 fixed to the base 27. The horizontal rack 46 is centred on the axis of rotation of the turntable 26 and is engaged by a second pinion 47 on the output shaft of a second geared motor 48, so that rotation of the pinion 47 causes the reflector 22, the porous tube 20, the non-porous tube 21 and their adjuncts to rotate as one with the turntable 26 about a vertical axis intersecting the mid-point of the focal line of the reflector 22.

Such rotation may occur without damage to or dislocation of the discharge pipe 23 or the feed pipe 24 due to the fact that the discharge pipe 23 includes a short stationary length 52 (see FIG. 3) that is coaxial with the axis of rotation of the turntable 26 and is connected to that part of the pipe which moves with the turntable by swivelling elbows and the feed pipe 24 includes a short length 53 that is also coaxial with the axis of rotation of the turntable 26 and turns with the turntable and is connected to the stationary part Of the pipe by swivelling elbows.

It will be clear from the foregoing to the skilled addressee that co-ordinated movement of the two pinions 44 and 47 may be used to cause the reflector 22 to track the sun and maintain the reflected solar radiation concentrated on the porous tube 20.

That coordinated movement may be effected by the electronic control unit, or, less preferably by a second such unit, in response to signals from an array of photo-detectors located within respective quadrant shaped pockets in the curved surface of an otherwise substantially semi-spherical body 49. Each pocket defines the field of view of the detector within it. The pockets extend from a centre point of the curved surface lying on a radius of the body 49 that is parallel to the parabolic axis of the reflector 22. The arrangement is such that, when all of the four detectors are lit by the sun the parabolic axis is necessarily directed at the sun. As the sun moves, one or more of the detectors becomes un-lit and the control unit processes the resultant signals and operates the motors 45 and 48 to re-direct the parabolic axis appropiately. If all the detectors are unfit (for example, at night) the control unit may operate the motors 45 and 48 so as to park the reflector in a pre-determined position, or simply allow it halt, until one or other of the detectors is re-lit.

Furthermore, when all the detectors are un-lit and evaporation ceases, the control unit may initiate a timed operation of flushing means to dissolve and clean away residual deposits of the material originally contaminating the feed liquid, and left within the pores or on the surface of the porous tube as a result of the evaporation of that liquid.

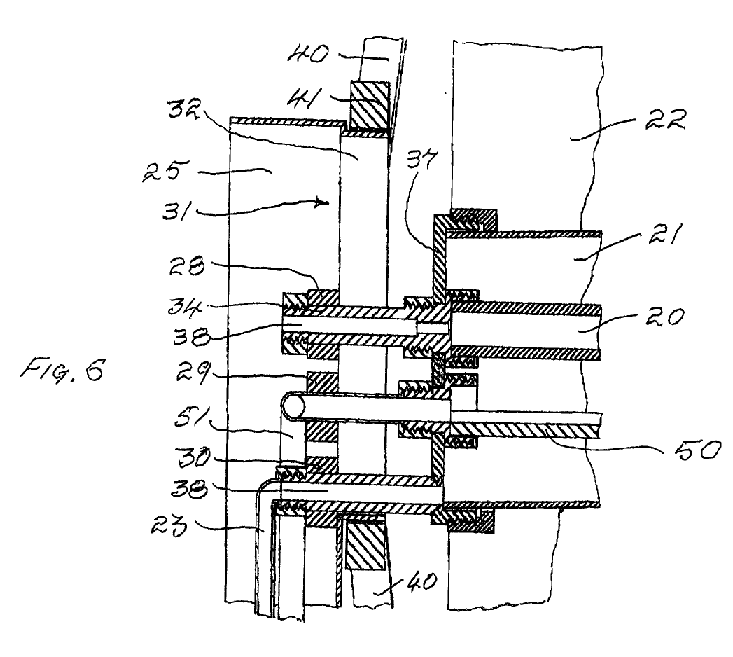

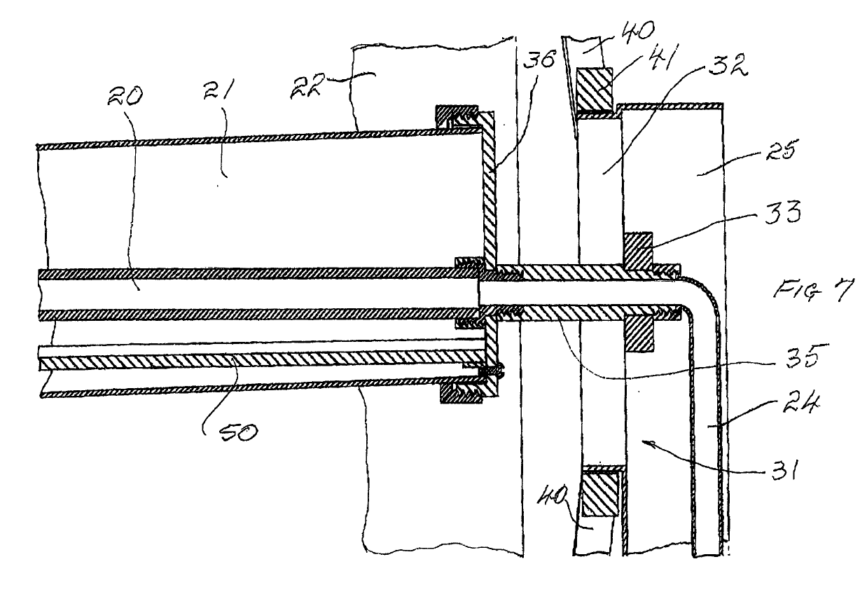

Those flushing means may comprise a catchment gutter 50 (see FIGS. 6 and 7) of the same material as that of thc non-porous tube 21. The gutter 50 extends between the end-caps 36 and 37 below the porous tube 20. It falls slightly towards end-cap 37, and discharges into a waste pipe 51 extending through the support bar 29 and an appropriate sealing fitting in the end-cap 37. When flushing is required the control unit simply overrides the signals from the thermometric element and fully opens the flow control valve. At other times the catchment gutter 50 and waste pipe 51 operate to catch and dispose of any drips of feed liquid from the porous tube 20 that may arise due to inaccurate functioning of the flow control means, so as to avoid contamination of the distillate.

The claims defining the invention are as follows:

1. A solar still comprising a hollow, porous absorber body, body positioning means to expose the absorber body to solar radiation, feed means to introduce feed liquid into the absorber body,
condenser means, of non-porous material that is substantially transparent to solar radiation, substantially enveloping the absorber body,
flow control means to regulate the rate of flow of feed liquid into the absorber body, and
harvesting means for the removal of distillate from the condenser means.

2. A solar still according to claim 1 wherein the absorber body comprises at least one rigid, porous tube of darkly coloured, sintered ceramic material, having two ends, and
said porous tube is open at one end to receive feed liquid and is closed at its other end to prevent flow of feed liquid therefrom.

3. A solar still according to claim 2 wherein said condenser means comprises at least one non-porous tube through which the at least one porous tube extends without making contact therewith,
and wherein the non-porous tube is of material that is substantially transparent to solar radiation.

4. A passive still according to claim 3 wherein there are a plurality of said porous tubes and a like plurality of said non-porous tubes respectively associated with the porous tubes in a substantially planar array wherein the porous tubes are parallel and spaced apart.

5. A passive still according to claim 4 wherein said body positioning means ensure that the array is inclined to the horizontal at an angle of inclination to suit the geographic location of the still so as to maximise the exposure of the tube array to solar radiation.

6. A passive still according to claim 5 wherein said feed means comprise a feed pipe extending from a source of feed liquid to a header to which each of said porous tubes are connected,
and wherein said flow control means comprise a valve in said feed pipe upstream of said header.

7. A passive still according to claim 5 wherein said harvesting means comprise an outlet spout adjacent a lower end of each said non-porous pipe and a collector gutter to receive distillate from those spouts.

8. A passive still according to claim 6 wherein said flow control means further comprise a thermometric element in thermal transmission relationship with feed liquid in one of said porous tubes and an electronic control unit responsive to signals from said thermometric element that operates said valve to achieve an operating temperature no greater than 100° C.

9. An active still according to claim 3 further comprising reflecting means to concentrate solar radiation onto said porous tube and tracking means to cause said reflecting means to track the sun.

10. An active still according to claim 9 wherein said reflecting means include a parabolic trough reflector having a focal line and a parabolic axis,
and wherein said body positioning means ensure that the at least one porous tube is substantially coaxial with said focal line,
and wherein said tracking means ensure that said parabolic axis remains substantially directed towards the sun when the still is producing distillate.

11. An active still according to claim 10 wherein said body positioning means comprise a stationary base, a turntable supported by said base for rotation about a substantially vertical axis and two spaced apart pillars extending upwardly from said turntable,
and wherein said porous tube and said non-porous tube extend between said pillars and are fixedly supported thereby,
and wherein said reflector extends between said pillars and is rotatably supported thereby,
and wherein the axis of rotation of the turntable intersects the axis of the porous tube and said focal line.

12. An active still according Lo claim 11 wherein said tracking means comprise a first motor drive connected to said reflector to effect rotation thereof about its focal line, a second motor drive connected to said turn-table to effect rotation thereof about its axis of rotation, and an electronic control unit responsive to signals from an array of photo-detectors that moves as one with the reflector,
and wherein the photo-detectors have respective discrete fields of view of the sky.

13. An active still according to claim 12 wherein the array of photo-detectors is symmetrical about a central axis of the array that is parallel to the parabolic axis of the reflector,
and wherein all of the detectors are lit by the sun when, and only when, the parabolic axis is directed at the sun.

14. An active still according to claim 13 such that if and when all, of the detectors are unlit the control unit de-energises both said motors to halt the reflector until such lime as at least one detector is re-lit.

15. An active still according to claim 13 such that if and when all of the detectors are unlit the control unit operates said motors so as to park the reflector in a pre-determined position, and then de-energises both said motors until such time as at least one detector is re-lit.

16. An active still according to claim 3 wherein said feed means comprise a feed pipe extending from a source of feed liquid to the open end of said porous tube, and wherein said flow control means comprise a valve in said feed pipe upstream of said open end.

17. An active still according to claim 16 wherein said flow control means further comprise a thermometric element in thermal transmission relationship with feed liquid in said porous tube and all electronic control unit responsive to signals from said thermometric element that operates said valve to achieve a maximum operating temperature no greater than 100° C.

18. An active still according to claim 3 further comprising a catchment gutter extending within and lengthwise of the non-porous tube underneath the porous tube and discharging to waste, said catchment gutter being adapted to catch any un-evaporated feed water dripping from the porous tube wall, including feed water fed into the porous tube during the night for flushing purposes

19. A method of distilling a feed liquid to produce a desired distillate comprising the steps of maintaining a flow of feed liquid into a porous, hollow absorber body, exposing the absorber body to solar radiation, and condensing resultant vapour arising from the absorber body.

20. A method according to claim 19 wherein said feed liquid is contaminated water and said distillate is potable water.
